(19) United States
(12) Patent Application Publication
(10) Pub. No.: US 2018/0121000 A1
(43) Pub. Date: May 3, 2018

(54) USING PRESSURE TO DIRECT USER INPUT

(71) Applicant: Microsoft Technology Licensing, LLC, Redmond, WA (US)

(72) Inventors: Christian Klein, Duvall, WA (US); Christopher M. Barth, Seattle, WA (US); Callil R. Capuozzo, Brooklyn, NY (US); Otso Joona Casimir Tuomi, Seattle, WA (US)

(21) Appl. No.: 15/336,372

(22) Filed: Oct. 27, 2016

(51) Int. Cl. G06F 3/041; G06F 3/0488; G06F 3/0484

(52) U.S. Cl. CPC G06F 3/0414; G06F 2203/04803; G06F 3/0484; G06F 3/04883

(57) ABSTRACT

Embodiments relate to using pressure of user inputs to select user interfaces and user interaction models. A computing device handling touch inputs that include respective pressure measures evaluate the pressure measures to determine how the touch inputs are to be handled. In this way, a user can use pressure to control how touch inputs are to be handled. In scenarios where multiple user interfaces or displays managed by a same operating system are both capable of being targeted by touch input from a same input device, user-controlled pressure can determine which display or user interface touch inputs will be associated with. Touch inputs can be directed, based on pressure, by modifying their event types, passing them to particular responder chains or points on responder chains, for example.

### BACKGROUND

Advances in software and hardware have resulted in new user interface problems. For example, some combinations of hardware and software enable a touch-screen computing device such as a mobile phone to simultaneously display output to the device's touch screen and to an external display. In such a case where the computing device displays interactive graphics on two displays, it is convenient to enable a user to use the touch-screen to direct input to a user interface displayed on the touch screen as well as to a user interface displayed on the external display. In this scenario, there is no efficient and intuitive way to enable a user to determine which user interface any particular touch input should be directed to (“user interface” broadly refers to units such as displays, application windows, controls/widgets, virtual desktops, and the like).

In general, it can be difficult to perform some types of interactions with touch input surfaces. For example, most windowing systems handle touch inputs in such a way that most touch inputs are likely to directly interact with any co-located user interface; providing input without interacting with an underlying user interface is often not possible. Moreover, when multiple user interfaces can potentially be targeted by a touch input, it has not been possible for a user to use formation of the touch input as a way to control which user interface will receive the touch input. Instead, dedicated mechanisms have been needed. For example, a special user interface element such as a virtual mouse or targeting cursor might be manipulated to designate a current user interface to be targeted by touch inputs.

In addition, it is sometimes desirable to differentiate between different sets of touch gestures. A gesture in one set might be handled by one user interface and a gesture in another set might be handled by another user interface. For example, one set of gestures might be reserved for invoking global or system commands and another set of gestures might be recognized for applications. Previously, sets of gestures have usually been differentiated based on geometric attributes of the gestures or by using reserved display areas. Both approaches have shortcomings. Using geometric features may require a user to remember many forms of gestures and an application developer may need to take into account the unavailability of certain gestures or gesture features. In addition, it may be difficult to add a new global gesture since existing applications and other software might already be using the potential new gesture. Reserved display areas can limit how user experiences are managed, and they can be unintuitive, challenging to manage, and difficult for a user to discern.

Only the inventors have appreciated that sensing surfaces that measure and output the pressure of touch points can be leveraged to address some of the problems mentioned above. User interaction models that use pressure-informed touch input points (“pressure points”) are described herein.

### SUMMARY

The following summary is included only to introduce some concepts discussed in the Detailed Description below. This summary is not comprehensive and is not intended to delineate the scope of the claimed subject matter, which is set forth by the claims presented at the end.

Embodiments relate to using pressure of user inputs to select user interfaces and user interaction models. A computing device handling touch inputs that include respective pressure measures evaluate the pressure measures to determine how the touch inputs are to be handled. In this way, a user can use pressure to control how touch inputs are to be handled. In scenarios where multiple user interfaces or displays managed by a same operating system are both capable of being targeted by touch input from a same input device, user-controlled pressure can determine which display or user interface touch inputs will be associated with. Touch inputs can be directed, based on pressure, by modifying their event types, passing them to particular responder chains or points on responder chains, for example.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows a computing device configured to provide a user interface on a first display and a user interface on a second display.

FIG. 2 shows details of the computing device.

FIG. 3 shows how pressure selection logic can be arranged to determine which input events are to be handled by which user interface units.

FIG. 4 shows a first application of the pressure selection logic.

FIG. 5 shows a second application of the pressure selection logic.

FIG. 6 shows pressure selection logic controlling which user interface elements of an application receive or handle input events.

FIG. 7 shows an embodiment of the pressure selection logic.

FIG. 8 shows an example of user input associating with a user interface according to input pressures and pressure conditions.

FIG. 9 shows a process of how a state machine or similar module of the pressure selection logic can handle a touch input with an associated pressure.

FIG. 10 shows a process for directing touch inputs to a target user interface.

FIG. 11 shows another process for directing user input to a user interface selected based on pressure of the user input.

FIG. 12 shows a multi-display embodiment.

FIG. 13 shows an embodiment where a user interface unit is activated or displayed in conjunction with being selected as an input target by the pressure selection logic.

FIG. 14 shows additional details of a computing device on which embodiments may be implemented.

### DETAILED DESCRIPTION

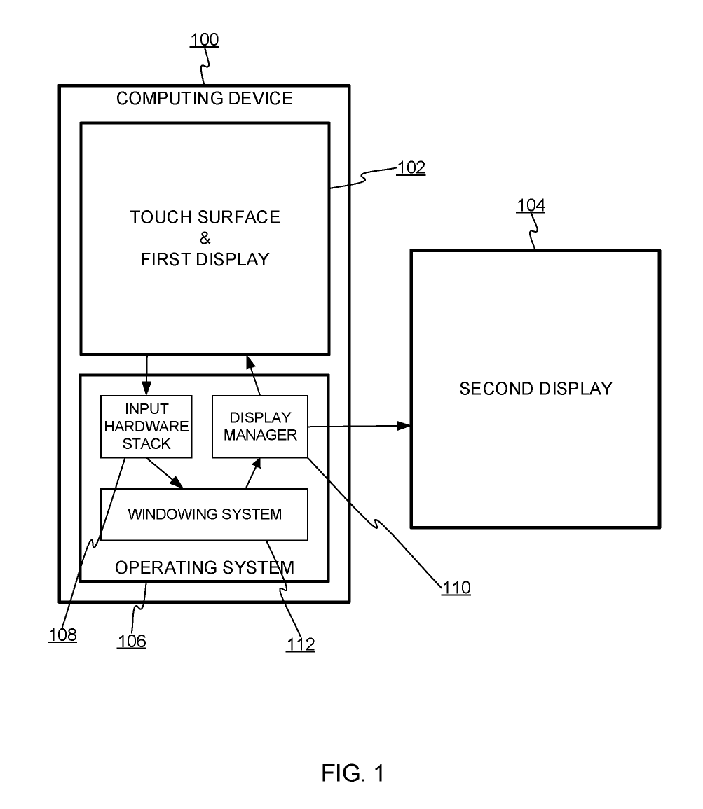

FIG. 1 shows a computing device 100 configured to provide a user interface on a first display 102 and a user interface on a second display 104. The first display 102 has touch and pressure sensing capabilities. An operating system 106 includes an input hardware stack 108, a display manager 110, and a windowing system 112. The input hardware stack 108 includes device drivers and other components that receive raw pressure points from the first display 102 and convert them to a form usable by the windowing system 112. The windowing system 112 provides known functionality such as receiving pressure points and dispatching them as events to the software of corresponding windows (e.g., applications), generating the graphics for windows, etc. The display manager 110 manages display of graphics generated by the windowing system 112 and may provide abstract display functionality for the windowing system 112 such as providing information about which displays are available and their properties.

The breakdown of functionality of modules shown in FIG. 1 is only an example of one type of environment in which embodiments described herein may be implemented. The embodiments described herein may be adapted to any computing device that displays graphics and uses a pressure-sensitive touch surface. The term “touch” is used herein to describe points inputted by any physical implement including fingers, pens, styluses, etc.

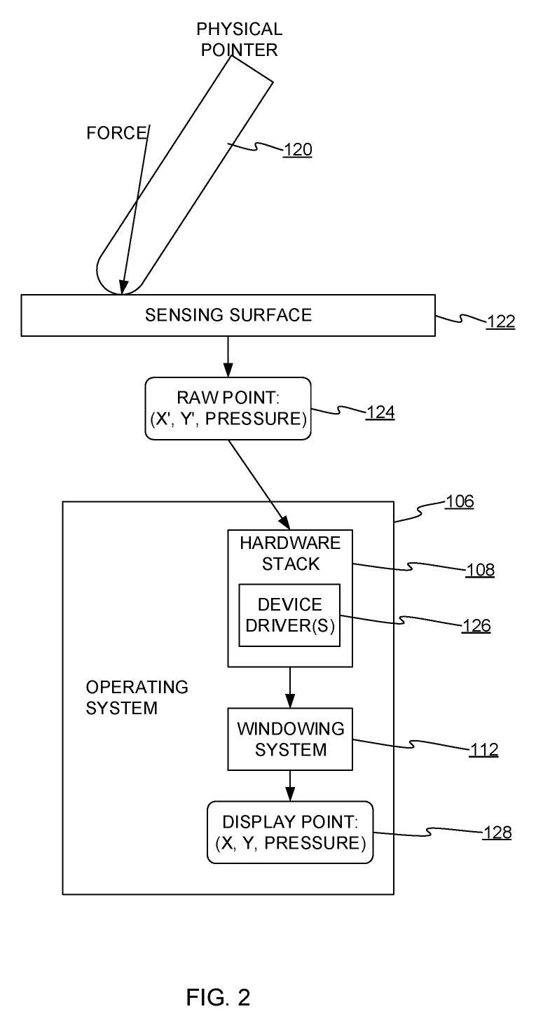

FIG. 2 shows additional details of the computing device 100. When a physical pointer 120 such as a finger or stylus contacts a sensing surface 122, the sensing surface 122 generates location signals that indicate the locations of the corresponding points of the sensing surface 122 contacted by the physical pointer 120. The sensing surface 122 also generates pressure signals that indicate measures of force applied by the physical pointer 120. Force or pressure sensing can be implemented based on displacement of the sensing surface, the shape formed by the contact points, heat, etc. Pressure can also be sensed by a physical implement such as a stylus or pen; the term “sensing surface” also refers to surfaces where pressure is sensed when the surface is used, yet the pressure sensing lies in the pen/stylus rather than the surface. Any means of estimating force applied by the physical pointer will suffice.

The sensing surface 122 outputs raw pressure points 124, each of which has device coordinates and a measure of pressure, for instance between zero and one. The hardware stack 108 receives the raw pressure points 124 which are passed on by a device driver 126. At some point between the hardware stack 108 and the windowing system 112 the raw pressure points are converted to display coordinates and outputted by the windowing system 112 as input events 128 to be passed down through a chain of responders or handlers perhaps starting within the windowing system 112 and ending at one or more applications.

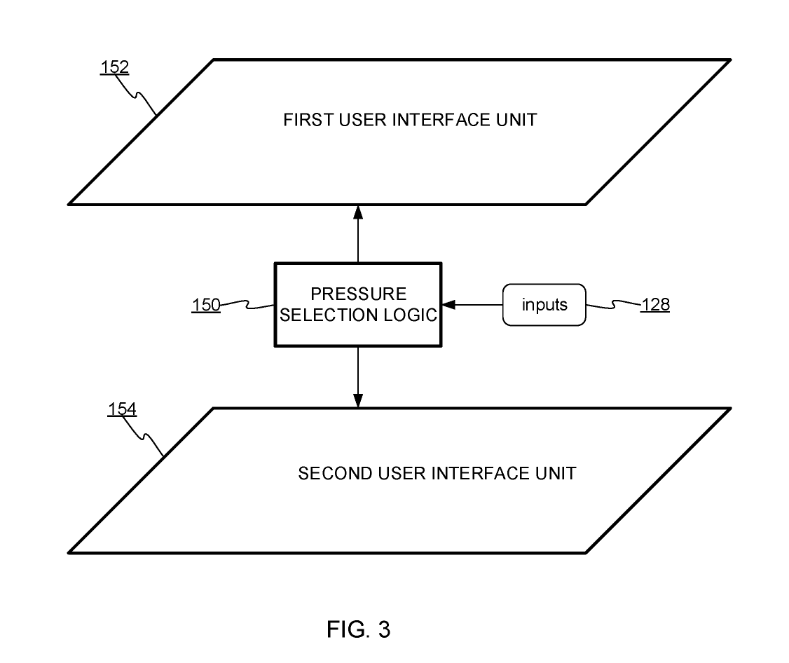

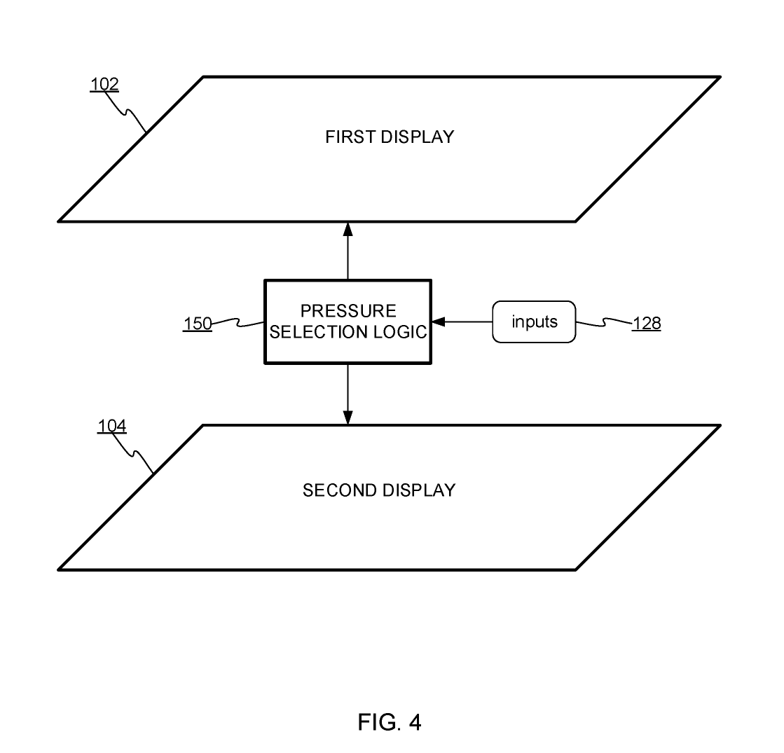

FIG. 3 shows how pressure selection logic 150 can be arranged to determine which input events 128 are to be handled by which user interface units. The pressure selection logic 150 may be implemented anywhere along an input responder chain. In one embodiment, the windowing system 112 implements the pressure selection logic 150. In another embodiment, a graphical user shell for managing applications provides the pressure selection logic. In yet another embodiment, the pressure selection logic 150 is implemented by an application to select between user interface elements of the application. As will be explained with reference to FIGS. 4 through 6, the first user interface unit 152 and the second user interface unit 154 can be any type of user interface object or unit, for instance, a display, a graphical user shell, an application or application window, a user interface element of an application window, a global gesture, a summonable global user interface control, etc. In addition, although the pressure selection logic 150 is described as controlling how input events 128 are directed to a user interface, destinations of other objects may also be selected by the pressure selection logic 150 based on the pressure of respective input points. For example, recognized gestures, other input events (actual, simulated, or modified), or other known types of events may be regulated by the pressure selection logic 150. An “input” or “input event” as used herein refers to individual input points, sets of input points, and gestures consisting of (or recognized from) input points.

FIG. 4 shows a first application of the pressure selection logic 150. Based on pressure inputs/events, input events 128 may be directed to either the first display 102 or the second display 104. For example, events associated with a first pressure condition are dispatched to the first display 102 and events associated with a second pressure condition are dispatched to the second display 104.

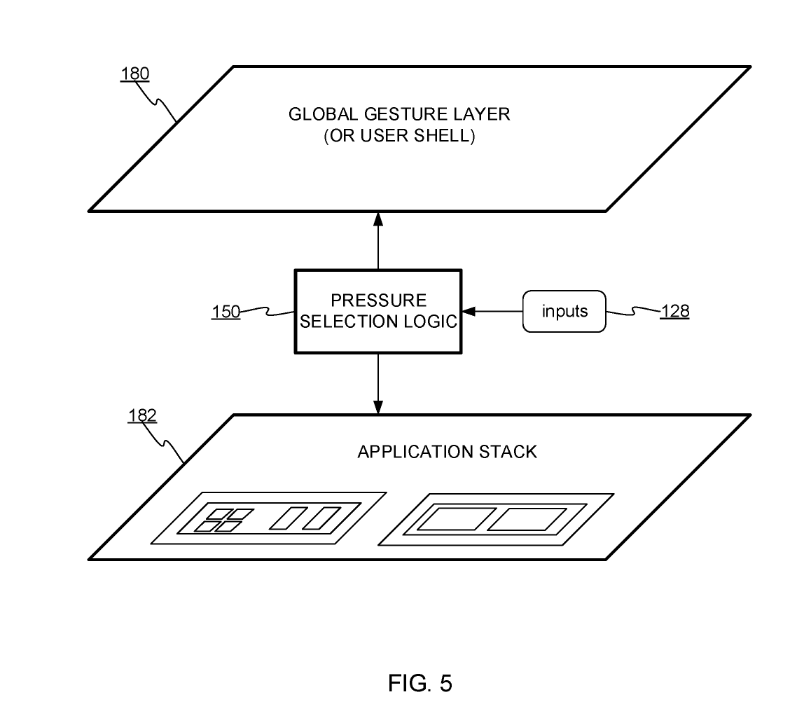

FIG. 5 shows a second application of the pressure selection logic 150. Based on pressure inputs/events, input events 128 are routed (or configured to be routed) to either a global gesture layer 180 or an application or application stack 182. That is, based on the pressure applied by a user to the pressure sensing surface 122, various corresponding user activity may be directed to either global gesture layer 180 or an application. The global gesture layer 180 may include one or more graphical user interface elements individually summonable and operable based on the pressure of corresponding inputs.

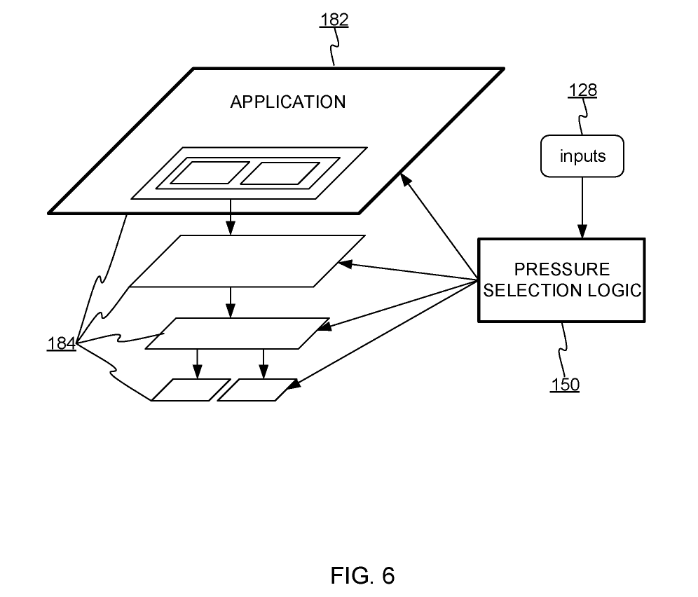

FIG. 6 shows pressure selection logic 150 controlling which user interface elements of an application receive or handle input events 128. The application 182 has a user interface which consists of a hierarchy of user interface elements 184 such as a main window, views, view groups, user interface controls, and so forth. The pressure selection logic 150 may help to determine which of these elements handles any given input such as a touch or pointer event, gesture, sequence of events, etc. Referring to FIG. 3, either of the user interface units 152, 154 may be any of the examples of FIGS. 4 through 6. That is, the pressure selection logic 150 can control whether a variety of types of inputs are received or handled by a variety of types of user interfaces or elements thereof. For example, the first user interface unit 152 might be a display object and the second user interface unit 154 might be an application object.

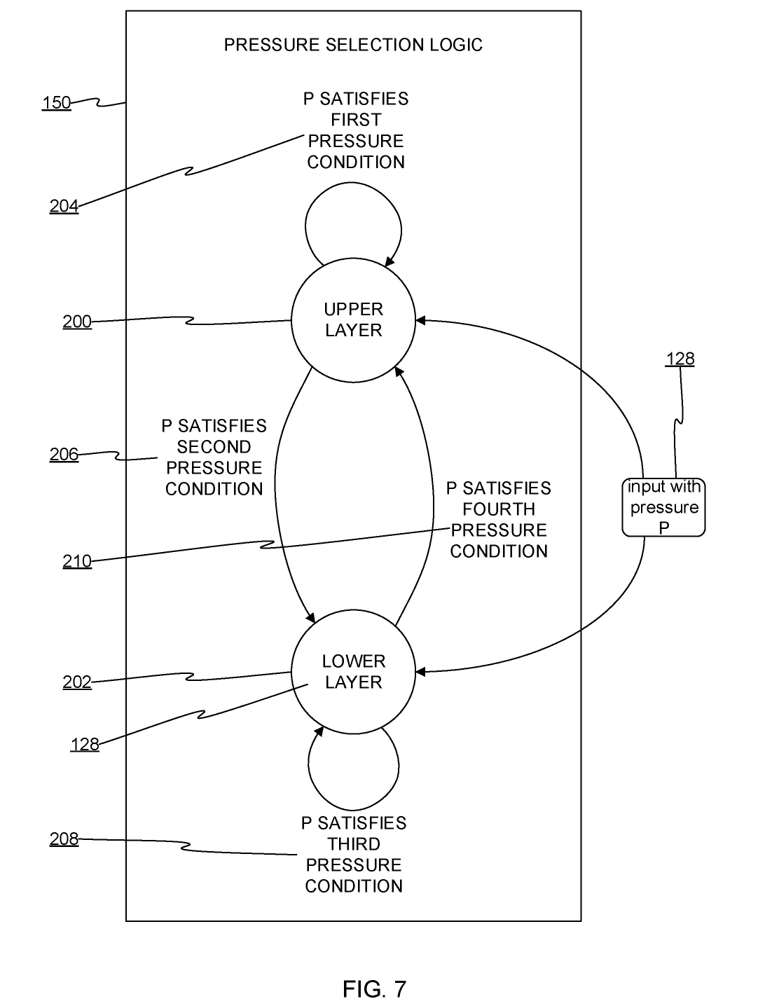

FIG. 7 shows an embodiment of the pressure selection logic 150. The pressure selection logic 150 implements a state machine where an upper layer state 200 represents the first user interface unit 152 and the lower layer state 202 represents the second user interface unit 154. The transitions or edges of the state machine are first, second, third, and fourth pressure conditions 204, 206, 208, 210 (some of the conditions may be equivalent to each other). When a new input event 128 arrives, which layer/interface the input event 128 is directed to by the pressure selection logic 150 depends on which state 200,202 the state machine is in and which pressure condition is satisfied by the pressure associated with the new input. The pressure associated with a new input can depend on what type of input is used. If the input is a set of input points, e.g. a stroke, then the pressure might be an average pressure of the first N input points, the average pressure of the first M milliseconds of input points, the maximum pressure for a subset of the input points, the pressure of a single input point (e.g. first or last), etc.

For discussion, pressure levels will be assumed to range linearly from 0 to 1, where 0 indicates no pressure, 1 indicates full pressure, 0.5 represents half pressure, and so forth. Also for discussion, simple pressure conditions will be assumed; the first and third pressure conditions 204, 208 are “is P below 0.5”, and the second and fourth pressure conditions 206, 208 are “is P above 0.5”. However, complex conditions can also be used, which will be described further below.

As noted above, the state machine controls which of the potential user interfaces input events are to be associated with. When a new input event 128 is received, the state machine determines whether its state should change to a new state based on the current state of the state machine. If a new input event is received and the state machine is in the upper layer state, then the pressure of the input event is evaluated against the first and second pressure conditions 204, 206 (in the case where the conditions are logically equivalent then only one condition is evaluated). If a new input event is received and the state machine is in the lower layer state, then the pressure of the input event is evaluated against the third and fourth pressure conditions 208, 210.

If the state machine is in the upper layer state and the input event has a pressure of 0.3, then the state machine stays in the upper layer state. If the state machine is in the upper layer state and the input event has a pressure of 0.6, then the state machine transitions to the lower layer state. The input event is designated to whichever user interface is represented by the state that is selected by the input event. Similarly, if the state machine is in the lower layer state when the input is received then the pressure is evaluated against the third and fourth conditions. If the input pressure is 0.2 then the fourth pressure condition is satisfied and the state transitions from the lower layer state to the upper layer state and the input event is designated to the first user interface. If the input pressure is 0.8 then the third condition is met and the state remains at the lower layer state and the input event is designated to the second user interface.

The thresholds or other conditions can be configured to help compensate for imprecise human pressure perception. For example, if the second condition has a threshold (e.g., 0.9) higher than the third condition's (e.g., 0.3), then the effect is that once the user has provided sufficient pressure to move the state to the lower layer, less pressure (if any, in the case of zero) is needed for the user's input to stay associated with the lower layer. This approach of using different thresholds to respectively enter and exit a state can be used for either state. Thresholds of less than zero or greater than one can be used to create a “sticky” state that only exits with a timeout or similar external signal. The state machine's state transitions can consider other factors, such as timeouts of external signals, in addition to the pressure thresholds.

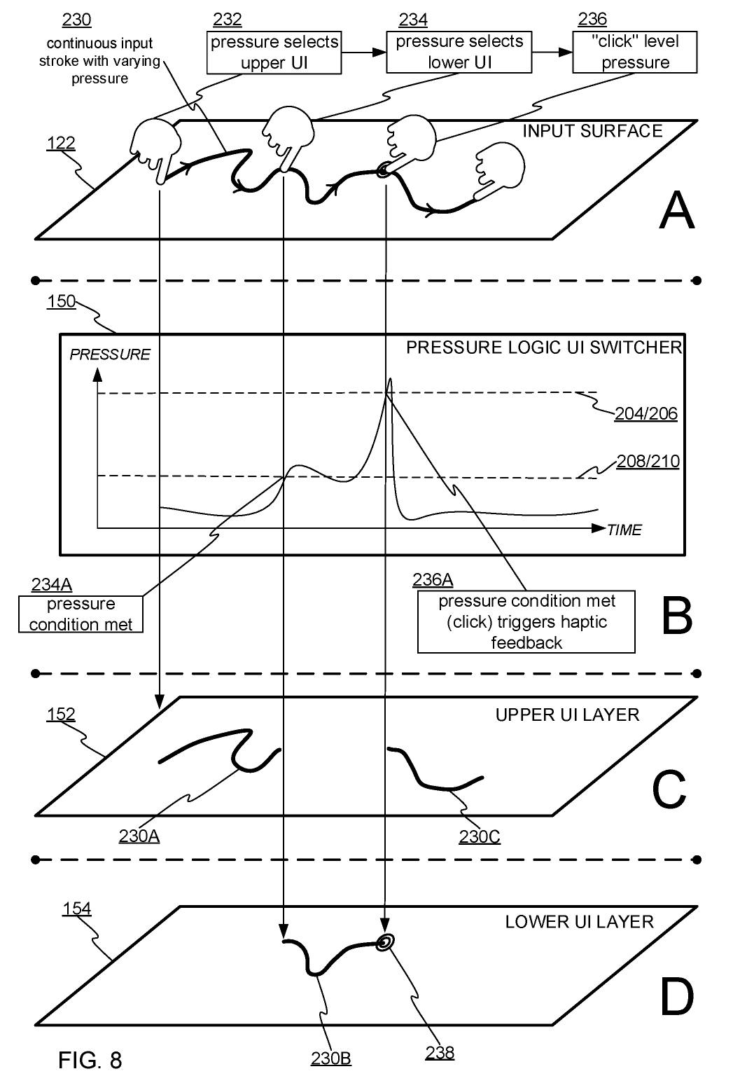

FIG. 8 shows an example of user input associating with a user interface according to input pressures and pressure conditions. FIG. 8 includes 4 concurrent sections A, B, C, and D as a user inputs a touch stroke from left to right. Initially, as shown in section A, a user begins inputting a touch stroke 230 on a sensing surface 122 (the lines in sections A, C, and D represents the path of the user's finger and may or may not be displayed as a corresponding graphical line).

At step 232, while the selection logic 150 is in a default state (e.g., a state for the first user interface unit 152), the user touches the sensing surface 122, which generates a pressure point that is handled by the selection logic 150. The pressure of the pressure point is evaluated and found to satisfy the first pressure condition 204, which transitions the state of the state machine from the upper layer state 200 to the upper layer state 200 (no state change), i.e., the pressure point is associated with the first user interface unit 152. The user's finger traces the touch stroke 230 while continuing to satisfy the first pressure condition 204. As a result, the selection logic 150 directs the corresponding touch events (pressure points) to the first user interface unit 152. In section B, while the input pressure initially remains below the first/second pressure condition 204/206 (e.g., 0.3), corresponding first pressure points 230A are directed to the first user interface unit 152.

At step 234, the pressure is increased and, while the state machine is in the upper layer state 200, a corresponding pressure point is evaluated at step 234A and found to satisfy the first/second pressure condition 204/206. Consequently, the selection logic 150 transitions its state to the lower layer state 202, which selects the second user interface unit 154 and causes subsequent second pressure points 230B to be directed to the second user interface unit 154. Depending on particulars of the pressure conditions, it is possible that, once in the lower layer state 202, the pressure can go below the pressure required to enter the state and yet the state remains in the lower layer state 202.

At step 236 the user has increased the pressure of the touch stroke 230 to the point where a pressure point is determined, at step 236A, to satisfy the third/fourth pressure condition 208/210. This causes the selection logic 150 to transition to the upper layer state 200 which selects the first user interface unit 152 as the current target user interface. Third pressure points 230C of the touch stroke are then directed to the first user interface unit 152 for possible handling thereby.

The selection logic 150 may perform other user interface related actions in conjunction with state changes. For example, at step 236, the selection logic 150 may invoke feedback to signal to the user that a state change has occurred. Feedback might be haptic, visual (e.g., a screen flash), and/or audio (e.g., a “click” sound). In addition, the selection logic 150 might modify or augment the stream of input events being generated by the touch stroke 230. For example, at step 236 the selection logic 150 might cause the input events to include known types of input events such as a “mouse button down” event, a “double tap” event, a “dwell event”, a “pointer up/down” event, a “click” event, a “long click” event, a “focus changed” event, a variety of action events, etc. For example, if haptic feedback and a “click” event 238 are generated at step 236 then this can simulate the appearance and effect of clicking a mechanical touch pad (as commonly found on laptop computers), a mouse button, or other input devices.

Another state-driven function of the selection logic 150 may be ignoring or deleting pressure points under certain conditions. For example, in one embodiment, the selection logic 150 might have a terminal state where a transition from the lower layer state 202 to the terminal state causes the selection logic 150 to take additional steps such as ignoring additional touch inputs for a period of time, etc.

In another embodiment, the lower layer state 202 might itself be a terminal state with no exit conditions. For example, when the lower layer state 202 is entered, the selection logic 150 may remain in the lower layer state 202 until a threshold inactivity period expires. A bounding box might be established around a point of the touch stroke 230 associated with a state transition and input in that bounding box might be automatically directed to a corresponding user interface until a period of inactivity within the bounding box occurs.

The selection logic 150 can also be implemented to generate graphics. For example, consider a case where the sensing surface 122 is being used to simulate a pointer device such as a mouse. One state (or transition-stage combination) can be used to trigger display of an inert pointer on one of the user interface units 152/154. If the first user interface 150 is a first display and the second user interface is a second display, the selection logic can issue instructions for a pointer graphic to be displayed on the second display. If the second user interface or display is capable of handling pointer-style input events (e.g., mouse, touch, generic pointer), then the pointer graphic can be generated by transforming corresponding pressure points into pointer-move events, which can allow associated software to respond to pointer-over or pointer-hover conditions. If the second user interface or display is incapable of (or not in a state for) handling the pointer-style input events then the selection logic 150, through the operating system, window manager, etc., can cause an inert graphic, such as a phantom finger, to be displayed on the second user interface or display, thus allowing the user to understand how their touch input currently physically correlates with the second user interface or display. When the user's input reaches a sufficient pressure, then the pressure points may be transformed or passed through as needed. Thus, a scenario can be implemented where a user (i) inputs inert first touch inputs at a first pressure level on a first display to move a graphic indicator on a second display, and (ii) inputs active second touch inputs at a second pressure level and, due to the indicator, knows where the active second touch inputs will take effect.

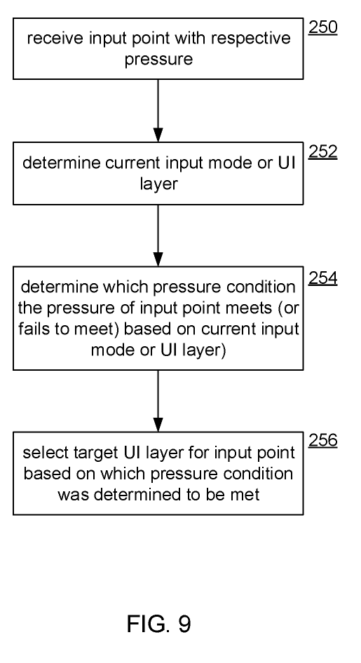

FIG. 9 shows a process of how a state machine or similar module of the pressure selection logic 150 can handle a touch input with an associated pressure. At step 250, the pressure selection logic 150 receives an input point that has an associated pressure measure. At step 252 the current input mode or user interface (UI) layer is determined, which may be obtained by checking the current state of the state machine, accessing a state variable, etc. The current input mode or UI layer 252 determines which pressure condition(s) need to be evaluated against the input point's pressure value. At step 256, a target input mode or UI layer is selected based on which pressure condition the pressure value maps to. Selecting or retaining the current input mode or UI layer may be a default action if no pressure condition is explicitly satisfied.

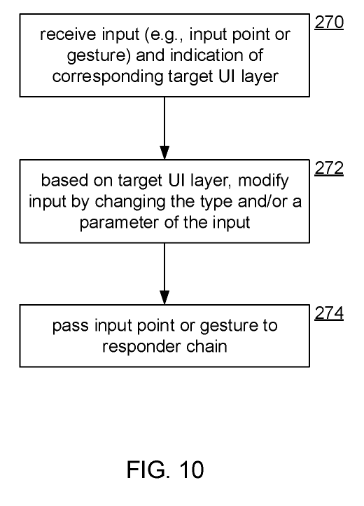

FIG. 10 shows a process for directing touch inputs to a target user interface. The process of FIG. 10 is one of many ways that user input can be steered once a particular target for the user input is known. At step 270, it is assumed that a given user input has been received and is to be dispatched. The user input could be in the form of a high level input such as a gesture, a description of an affine transform, a system or shell command, etc. At step 272, based on the target user interface, the user input is modified. This might involve changing an event type of the user input (e.g., from a mouse-hover event to a mouse-down event). This type of modification might continue until another state change occurs, thus the stream of input events can continue to be modified to be “down” events until a termination condition or pressure condition occurs. If the user input is a stream of pointer events, the user input can be modified by constructing an artificial event and injecting the artificial event into the stream of events. For instance, a “click” event or “down” event can be inserted at a mid-point between the locations of two actual touch points. At step 274 the modified/augmented inputs are passed through the responder chain just like any other input event. The inputs are directed to the target user interface based on their content. That is, some modified or augmented feature of the input has a side effect of causing the input to be handled by the user interface selected by the pressure selection logic 150.

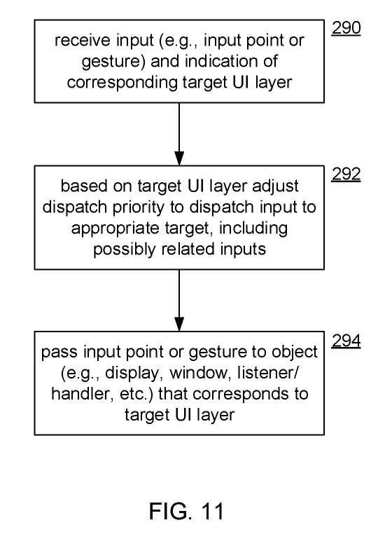

FIG. 11 shows another process for directing user input to a user interface selected based on pressure of the user input. Again, it is assumed that a user interface has been selected by any of the methods described above. At step 290, the pressure selection logic 150 receives an input point and an indication of a corresponding target UI layer. At step 292, based on the target UI layer, the relevant input is dispatched to the target UI layer directly by bypassing any necessary intermediate UI layers. For example, consider a target UI layer that is application2 in a responder chain such as (a) user shell->(b) application1->(c) application2. In this case, the user input event is dispatched to application2, bypassing the user shell and application 1. If the target UI layer is a display, for instance the second display 104, Given a set of possible responder chains: (1) window manager->first display 102, and (2) window manager->second display 104, then the second responder chain is selected.

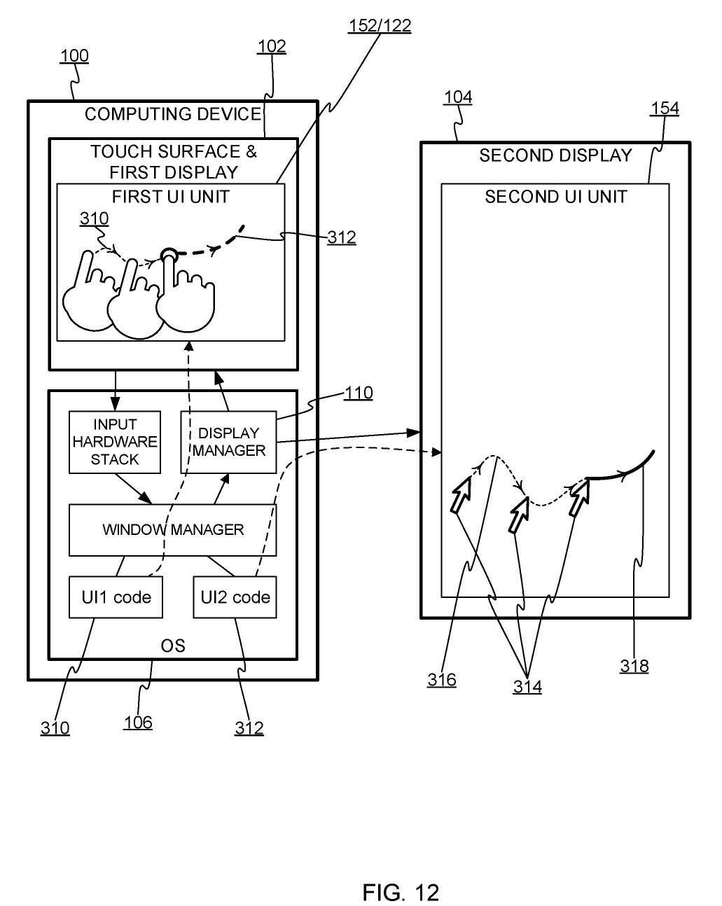

FIG. 12 shows a multi-display embodiment. The operating system 106 is configured to display a first user interface unit 152 on a first display 102 (a display is another form of a user interface unit, and in some contexts herein “display” and “user interface” are interchangeable). The operating system is also configured to display a second user interface unit 154 on a second display 104. The first display 102 and first user interface unit 152 are managed as a typical graphical workspace with toolbars, menus such as “recently used applications”, task switching, etc. First code 310 manages the first user interface unit 152, and second code 312 manages the second user interface unit 154. The first display 102 also includes a sensing surface or layer. The operating system is configured to enable the first display 102 to be used to provide input to both (i) the first code 310 to control graphics displayed on the first display 102, and (ii) the second code 312 to control graphics displayed on the second display 104. The pressure selection logic 150 is implemented anywhere in the operating system 106, either as a separate module or dispersed among one or more known components such as the input hardware stack, the window manager, a user shell or login environment, and so forth.

Initially, in FIG. 12, the first display 102 is displaying a first user interface unit 152. The first user interface unit 152 is the default or current target UI. The user begins to touch the sensing surface 122 to input first touch input 310. The first touch input 310 is below a threshold pressure condition and so the pressure selection logic 150 associates the first touch input 310 with the first user interface unit 152. In one embodiment, although the first touch input 310 does not interact with the second user interface unit 154, a pointer graphic 314 may be displayed to indicate the position of the input point relative to the second user interface unit 154.

When the user touches the sensing surface 122 with pressure above (or below) a threshold (second touch input 312), the pressure selection logic 150 takes action to cause the second touch input 312 to associate with the second user interface unit 154 and/or the second display 104. The lower-pressure first touch input 310 is represented by dashed lines on the first user interface unit 152 and the second user interface unit 154. The higher-pressure second touch input 312 is represented by a dashed line on the sensing surface 122 to signify that the input occurs on the first display 102 but does not act on the second user interface unit 154. A similar line 316 on the second user interface unit 154 shows the path of the pointer graphic 314 according to the first touch input 310. The higher-pressure second touch input 312 is represented by a solid line 318 on the second user interface unit 154 to signify that the second touch input 312 operates on the second display/UI.

If the first touch input 310 begins being inputted with pressure above the threshold, then the first touch input 310 would begin to immediately associated with the second user interface unit 154. Similarly, if the second touch input 312 does not exceed the threshold then the second touch input would associate with the first user interface unit 152 instead of the second user interface unit 154. Moreover, other types of inputs besides strokes may be used. The inputs may be merely dwells at a same input point but with different pressure; i.e. dwell inputs/events might be directed to the first user interface unit 152 until the dwelling input point increases to sufficient pressure to associate with the second user interface unit 154. The inputs might also be taps or gestures that include a pressure component; a first low-pressure tap is directed to the first user interface unit 152 and a second higher-pressure tap is directed to the second user interface unit 154.

In another embodiment, the user is able to control how input is handled in combination with gestures. That is, gestures may have a pressure component. Gestures meeting a first pressure condition (e.g., initial pressure, average pressure, etc.) may be directed to the first user interface and gestures meeting a second pressure condition may be directed to the second user interface. Multi-finger embodiments can also be implemented. Multi-finger inputs can entail either multiple simultaneous pointer events (e.g. tapping with two fingers) or a multi-finger gesture (e.g. a pinch or two-finger swipe). While the preceding paragraphs all relate to interactions that parallel traditional mouse UI, extension to multi-finger interactions allows a user to play games (slicing multiple fruit in a popular fruit-slicing game) or perform other more advanced interactions on the external display while providing pressure-sensitive input on the device.

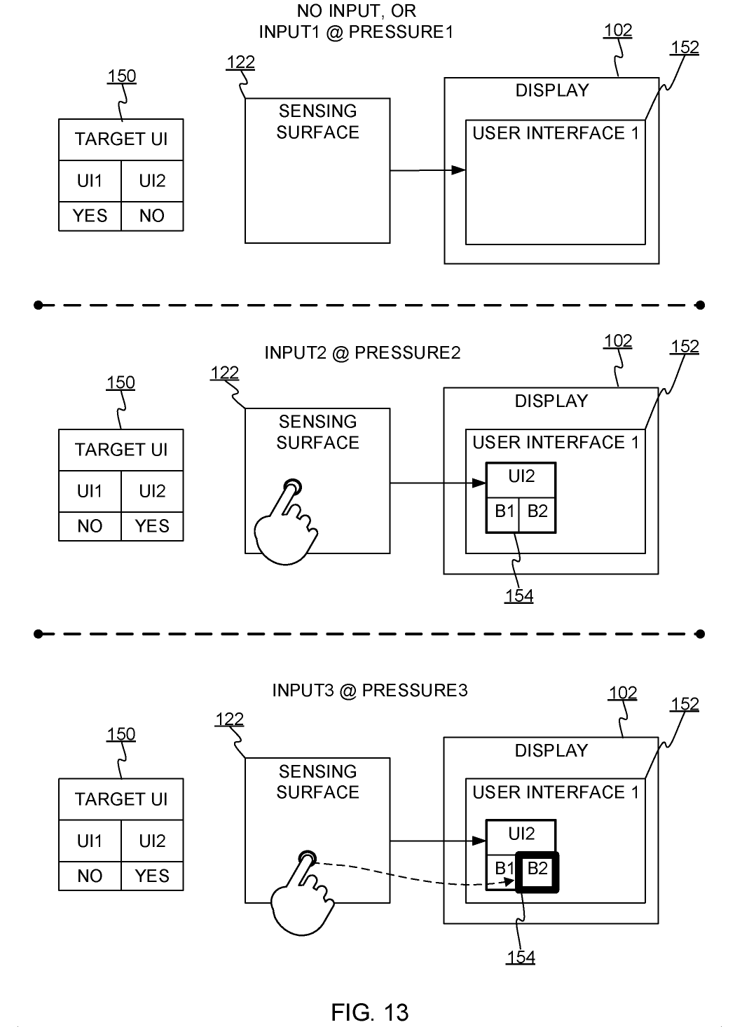

FIG. 13 shows an embodiment where a user interface is activated or displayed in conjunction with being selected as an input target by the pressure selection logic 150. At the top of FIG. 13, the state of the pressure selection logic 150 is set to the first user interface unit 152, either by default due to absence of input or as a result of input being provided at a first pressure that does not meet a pressure condition for selecting the second user interface unit 154. At the middle of FIG. 13, when the user touches the sensing surface 122, the corresponding user input is found to satisfy a pressure condition and the second user interface unit 154 is selected. The second user interface unit 154 is not displayed, opened, activated, etc., until the corresponding pressure condition is met.

The user interface unit 154 of FIG. 13 may be an ephemeral tool bar, user control, media player control, cut-and-paste tool, an input area for inputting gestures to invoke respective commands, etc. Although the sensing surface 122 may have initially been in a state of being capable of providing input to the first user interface unit 152 (given appropriate pressure conditions), the sensing surface 122 is essentially co-opted to another purpose based at least in part on the user's intentional use of pressure. Moreover, the input (e.g., “INPUT2”) whose pressure level contributed to selection of the second user interface unit 154 can also be also have a role in selecting the second user interface unit 154. If multiple hidden or uninstantiated user interfaces are available, which one of them is activated can be determined by performing gesture recognition on the input; any of the gestures, if inputted with the requisite pressure condition, will summon the respective second user interface. One gesture having a pressure that satisfies a pressure condition may summon a media playback control, whereas another gesture having a pressure that satisfies the same pressure condition may summon a cut-and-paste control for invoking cut-and-paste commands.

As shown in FIG. 13, a user interface that is summoned based on a pressure of a corresponding input might have elements such as buttons (“B1”, “B2”) or other controls that can be activated by user input meeting whatever pressure condition, if any, is currently associated with the state of the pressure selection logic 150. As shown at the bottom of FIG. 13, button “B2” is selected by a user input that is directed to the second user interface unit 154. The activating user input can be directed to the second user interface unit 154 and its button based on the second user interface being the current selected state of the pressure selection logic 150 and without regard for the input's pressure. Alternatively, the activating user input can be directed to the second user interface unit 154 based on the input satisfying a pressure condition of the current state of the pressure selection logic 150. For example, the second user interface may have been displayed responsive to detecting an invoking-input that satisfies a first pressure condition (e.g., “high” pressure). Then, the button “B2” of the second user interface may have been activated responsive to detecting an appropriate activating-input that also satisfies a second pressure condition. If the first pressure condition is a minimum high-pressure threshold and the second pressure condition is a minimum medium-pressure threshold, then the second user interface can be summoned using a hard input and then interacted with using a firm input. The activating-input may or may not be required to be a continuation of the invoking-input, depending on the implementation.

The example of FIG. 13 illustrates how a set of related user interactions can be controlled based on an initial pressure provided by the user. If an initial input pressure indicates that a particular user interface is to be targeted, all subsequent input within a defined scope of interaction can be directed to the indicated user interface based on the initial input pressure. The scope of interaction can be limited by, for example, a set amount of time without any interactions or inputs, a dismissal gesture or pre-defined pressure input, an interaction outside a bounding box around the pressure-triggering input, an input of any pressure outside the indicated user interface, etc.

Many variations are possible. Of note is the notion of using pressure as a means of enabling a user to control how touch inputs are to be handled when touch inputs have the potential to affect multiple user interfaces, such as when one pressure sensing surface is concurrently available to provide input to two different targets such as: two displays, two overlapping user interfaces, global or shell gestures and application-specific gestures, and others.

Moreover, the pressure selection techniques described herein can be used to select different interaction modalities or interaction models. As noted above, measures of input pressure can be used to alter or augment input event streams. If an application is configured only for one form of pointer input, such as mouse-type input, then pressure can be used to select an input mode where touch input events are translated into mouse input events to simulate use of a mouse. Although embodiments are described above as involving selection of a user interface using pressure, the same pressure-based selection techniques can be used to select input modes or interaction models.

In some embodiments, it may be helpful to evaluate only the initial pressure of an input against a pressure condition. When a stroke, swipe, tap, dwell, or combination thereof is initiated, the initial pressure may be evaluated to determine which user interface the entire input will be directed to. If a tap is evaluated, the average pressure for the first 10 milliseconds might serve as the evaluation condition, and any subsequent input from the same touch, stroke, etc., is all directed to the same target.

While thresholds have been mentioned as types of pressure conditions, time-based conditions may also be used. The rate of pressure change, for instance, can be used. Also, pressure conditions can be implemented as a pressure function, where pressure measured as a function of time is compared to values of a time-based pressure function, pattern, or profile.

Because touch inputs might be inputted on one device and displayed on another device, a user may in a sense be operating the input device without looking at the input device. To help the user perceive where a touch point is moving, haptic feedback can be used based on the touch point encountering objects. For example, if a touch input is moved logically over the edge of a graphic object, haptic feedback can be triggered by the intersection of the re-directed touch input and the graphic object, thus giving the user a sense of touching the edge of the object. The same approach can be useful for perceiving the boundaries of the target user interface. If only a certain area of the sensing surface is mapped to the target user interface, then haptic feedback can be triggered when a touch point reaches the edge of that area, thus informing the user. This haptic feedback technique can be particularly useful during drag-and-drop operations to let the user know when a potential drop target has been reached. Preferably, haptic feedback is used in combination with visual feedback shown on the external display (at which the user is presumably looking).

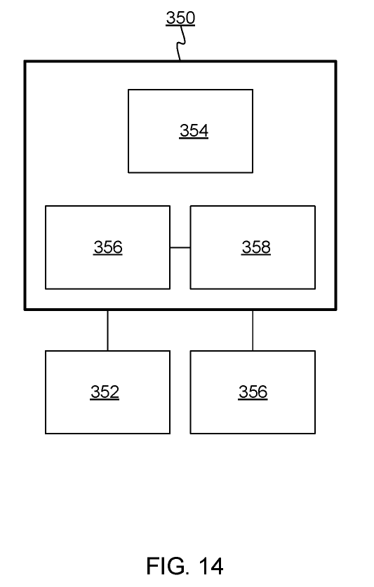

FIG. 14 shows details of a computing device 350 on which embodiments described above may be implemented. The technical disclosures herein will suffice for programmers to write software, and/or configure reconfigurable processing hardware (e.g., field-programmable gate arrays), and/or design application-specific integrated circuits (application-specific integrated circuits), etc., to run on the computing device 350 to implement any of features or embodiments described herein.

The computing device 350 may have one or more displays 102/104, a network interface 354 (or several), as well as storage hardware 356 and processing hardware 358, which may be a combination of any one or more: central processing units, graphics processing units, analog-to-digital converters, bus chips, FPGAs, ASICs, Application-specific Standard Products (ASSPs), or Complex Programmable Logic Devices (CPLDs), etc. The storage hardware 356 may be any combination of magnetic storage, static memory, volatile memory, non-volatile memory, optically or magnetically readable matter, etc. The meaning of the term “storage”, as used herein does not refer to signals or energy per se, but rather refers to physical apparatuses and states of matter. The hardware elements of the computing device 350 may cooperate in ways well understood in the art of computing. In addition, input devices may be integrated with or in communication with the computing device 350. The computing device 300 may have any form-factor or may be used in any type of encompassing device. The computing device 350 may be in the form of a handheld device such as a smartphone, a tablet computer, a gaming device, a server, a rack-mounted or backplaned computer-on-a-board, a system-on-a-chip, or others.

Embodiments and features discussed above can be realized in the form of information stored in volatile or non-volatile computer or device readable storage hardware. This is deemed to include at least hardware such as optical storage (e.g., compact-disk read-only memory (CD-ROM)), magnetic media, flash read-only memory (ROM), or any current or means of storing digital information. The stored information can be in the form of machine executable instructions (e.g., compiled executable binary code), source code, bytecode, or any other information that can be used to enable or configure computing devices to perform the various embodiments discussed above. This is also deemed to include at least volatile memory such as random-access memory (RAM) and/or virtual memory storing information such as central processing unit (CPU) instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A method performed by a computing device comprised of storage hardware and processing hardware, the method comprising:
providing a first and second user interface, wherein either of the user interfaces can be interacted with through touch inputs inputted through a pressure sensing surface;
receiving a first touch input inputted through the pressure sensing surface, the first touch input comprising a two-dimensional point and a pressure value associated with the two-dimensional point;
designating one of the user interfaces as a target user interface by evaluating the pressure value against a pressure condition, wherein which of the user interfaces is designated as the target user interface depends on whether the pressure condition is satisfied by the pressure value; and
directing the first touch input and subsequent touch inputs associated with the touch input to the designated user interface.

2. A method according to claim 1, wherein the first user interface comprises a first display, the second user interface comprises a second display, and the pressure condition controls which touch inputs will be directed to which of the displays.

3. A method according to claim 2, further comprising executing, by an operating system executing of the computing device, first code that manages the first user interface and second code that manages the second user interface, wherein the first display comprises the pressure sensing surface, wherein the first input is inputted by a contact above the first user interface, and wherein the first input and the subsequent user inputs are directed to the second user interface on the second display based on the pressure condition.

4. A method according to claim 1, wherein the first touch input corresponds to a first contact with the sensing surface and the subsequent touch inputs comprise respective other discrete contacts with the sensing surface.

5. A method according to claim 4, wherein the subsequent touch inputs are directed to the designated user interface without regard for pressures of the respective subsequent inputs.

6. A method according to claim 1, wherein the first touch input and the subsequent touch input comprises respective touch events, and wherein the designating comprises altering the touch events and the altered touch events are handled by the designated by the designated user interface based on the alteration thereof.

7. A method according to claim 1, wherein the first touch input and the subsequent touch inputs comprise respective touch events, and wherein the designating comprises delivering the touch events to the designated user interface and the touch events bypass the user interface that was not designated as the target user interface.

8. A computing device comprising:
processing hardware;
a pressure-sensing touch display configured to detect input points and respective pressures of the input points;
storage hardware storing information, including an operating system, configured to cause the processing hardware to perform a process comprising:
displaying a first user interface;
providing a second user interface;
receiving a pressure point from the pressure-sensing display and determining that the pressure point satisfies a pressure condition associated with the second user interface;
based on the determining, displaying the second user interface; and
after the determining, while the second user interface continues to be displayed, receiving other pressure points inputted after the pressure point, and determining whether the other pressure points are to be handled by the second user interface based on pressure values of the respective other pressure points.

8. (canceled)

9. A computing device according to claim 7, wherein an input stroke comprises the pressure point and the other pressure points, the input stroke corresponding to a stroke of uninterrupted contact with the pressure-sensing display, the process further comprising evaluating the other pressure points against a second pressure condition.

10. A computing device according to claim 9, wherein the other pressure points do not interact with the second user interface until, according to the evaluating, the second pressure condition is satisfied by the other pressure points.

11. A computing device according to claim 7, the process further comprising modifying an attribute or event type of a given pressure point based on a pressure value of the given pressure point.

12. A computing device according to claim 7, wherein the second user interface comprises a graphic pointer that simulates a mouse pointer.

13. A computing device according to claim 7, further comprising selecting the second user interface, from among a plurality of user interfaces, based on a non-pressure feature of the pressure point and the other pressure points.

14. A method performed by a computing device, the method comprising:
displaying a first user interface and a second user interface;
receiving pressure inputs inputted by a contact with a display displaying the first user interface, the contact and pressure inputs coinciding with locations of the first user interface on the display; and
controlling, by an operating system of the computing device, whether the pressure inputs are to be handled by the first user interface or the second user interface based on pressures of the respective pressure inputs.

15. A method according to claim 14, wherein pressure inputs determined to satisfy the pressure condition are handled by the first user interface and pressure inputs determined to not satisfy the pressure condition are handled by the second user interface.

16. A method according to claim 14, wherein the second user interface is displayed on a second display.

17. A method according to claim 16, the method further comprising simulating a pointer input device by causing a graphic pointer to be displayed on the second display according to locations of the pressure inputs and triggering a click or down event responsive to determining that one of the pressure inputs satisfies a second pressure condition.

18. A method according to claim 14, wherein the second user interface continues to be displayed while the pressures of the respective pressure inputs are evaluated.

19. A method according to claim 14, further comprising responding to determining that a pressure input satisfies a pressure condition by causing subsequent pressure inputs to associate with one of the corresponding user interfaces.

20. A method according to claim 14, further comprising alternating between directing the pressure inputs to the first user interface and the second user interface according to the respective pressures of the pressure inputs.
